(19) United States
(12) Patent Application Publication
(10) Pub. No.: US 2009/0016809 A1
(43) Pub. Date: Jan. 15, 2009

(54) JOINT ARRANGEMENT

(76) Inventors: Reinhard Buhl, Bohmte (DE); Wolfgang Kleiner, Wagenfeld (DE)

Correspondence Address: MCGLEW & TUTTLE, PC, P.O. BOX 9227, SCARBOROUGH STATION, SCARBOROUGH, NY, 10510-9227, US

(21) Appl. No.: 11/996,807

(22) PCT Filed: Jul. 28, 2006
(86) PCT No.: PCT/DE2006/001313

§ 371 Date: Oct. 1, 2008

(30) Foreign Application Priority Data
Jul. 28, 2005 (DE) 10 2005 035 911.6

(51) Int. Cl. F16C 11/00

(52) U.S. Cl. 403/75

(57) ABSTRACT

A joint arrangement (8) is provided with a joint (15; 22), which can be stressed at least axially and on bending. The joint has an outer joint shell (17; 25) and an inner joint body (16; 23) that is movable in relation thereto. The joint axis (A1) is located at a spaced location (e) from the central axis (A2) located centrally in the joint (15; 22).

### CROSS REFERENCE TO RELATED APPLICATIONS

This application is a United States National Phase application of International Application PCT/DE 2006/001313 and claims the benefit of priority under 35 U.S.C. § 119 of German Patent Application 10 2005 035 911.6 filed Jul. 28, 2005, the entire contents of which are incorporated herein by reference.

### FIELD OF THE INVENTION

The present invention pertains to a joint arrangement with a joint which can be stressed at least axially and on bending, and which comprises an outer joint shell and an inner joint body movable in relation thereto and present invention pertains to a motor vehicle with at least one such joint arrangement.

### BACKGROUND OF THE INVENTION

Joint arrangements are provided in motor vehicle chassis at a plurality of points for connecting parts that are movable in relation to one another in the chassis or in the steering. Tolerances of the particular components must now be compensated by adapting the position and/or the orientation of the joint arrangement corresponding to these tolerances.

It is known, for example, that a joint arrangement can be fixed to the extending end of the suspension arm for connecting a lower suspension arm to the wheel carrier being held thereon, the joint arrangement being mounted for this purpose on a mounting plate provided with three elongated holes. This mounting plate can then be screwed to the end of the suspension arm, and a possibility of adjustment is obtained by means of the elongated holes. The pivot pin projecting upward from the mounting plate passes through the wheel carrier and can be secured by a screw connection above the wheel carrier.

Such an orientation by means of a plurality of screws in elongated holes means a great assembly effort.

### SUMMARY OF THE INVENTION

The basic object of the present invention is to achieve an improvement of tolerance compensation in the position and/or orientation of joint arrangements of a motor vehicle chassis.

According to the invention, a joint arrangement is provided including a joint which can be stressed at least axially and on bending. The joint comprises an outer joint shell and an inner joint body movable in relation to the joint shell and providing a joint axis located at a spaced location from a central axis located centrally in said joint.

Tolerance compensation can take place due to the fact that the joint axis in the joint arrangement is located at a spaced location from the central axis located centrally in the joint. Deviations from the intended position of the joint axis can be compensated by the joint axis, which coincided before with the central axis, being installed at a spaced location such that the joint axis assumes the installed position that is optimal when the tolerances are taken into account.

If the joint axis is located in parallel to the central axis, orientation is simplified and it takes into account only deviations in a plane cut by the joint axis vertically.

If the eccentricity of the joint axis in relation to the central axis can be set and fixed in an especially advantageous manner, orientation can be performed individually and depending on the concrete tolerance deviation during assembly.

The joint may be especially a sleeve joint with an eccentrically arranged through hole. In this case a pivot arranged in a fixed manner on a component that is to be connected can mesh with this hole and be displaced into a fitting position by orienting the eccentric through hole.

In another application, the joint may comprise as the joint body a ball head, which is movable in the joint shell and from which a pivot pin exits eccentrically for tolerance compensation. By rotating the joint body, the transverse distance of the mount of the pin can be set variably. This setting can be performed with the wheel mounted and fixed by tightening the only one fastening means securing the pivot on the suspension arm, for example, a union nut. The effort needed for setting is thus minimized.

As an alternative, a pivot pin may extend centrally with the pin in a joint of a similar design, the receiving joint shell itself being movable about a central axis.

An especially favorable application of the present invention is in a motor vehicle at the articulated connection between a control arm guiding and/or carrying a wheel and a wheel carrier movably connected to this control arm and to the wheel carrier.

In reversing the hitherto known conditions, the joint arrangement may receive, in particular, a pin pointing rigidly outwardly from the wheel carrier and hold this at the suspension arm.

As a result, the fastening between the wheel carrier and the suspension arm is displaced radially and outwardly in relation to the wheel axis. There is no fastening means now in the space between the wheel carrier and the hub, and no intervention is needed here during assembly and disassembly. The extension arm of the wheel carrier can thus be moved closer to the hub, and floating is increased in relation to the wheel flange. This advantageous feature becomes manifest especially on a McPherson axle, in which a drive shell passes through the wheel carrier above the pin connecting same to the suspension arm, so that particular attention must be paid to the space problem here.

Other advantages and features of the present invention appear from the exemplary embodiments of the subject of the present invention, which are shown in the drawings and will be described below. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a joint arrangement according to the present invention at a control arm of a driven wheel of a motor vehicle chassis;

FIG. 2 is a schematic exploded view of the connecting parts in FIG. 1 with a sleeve joint is section in the cross rail;

FIG. 3 is a top view of the sleeve joint according to FIG. 2, which is received in the cross rail; and

FIG. 4 is a view similar to that in FIG. 2, but with an alternative arrangement with a ball and socket joint with a pin in the suspension arm, which can be fixed in the wheel carrier by means of a settable eccentric abutment.

### DESCRIPTION OF THE PREFERRED EMBODIMENTS

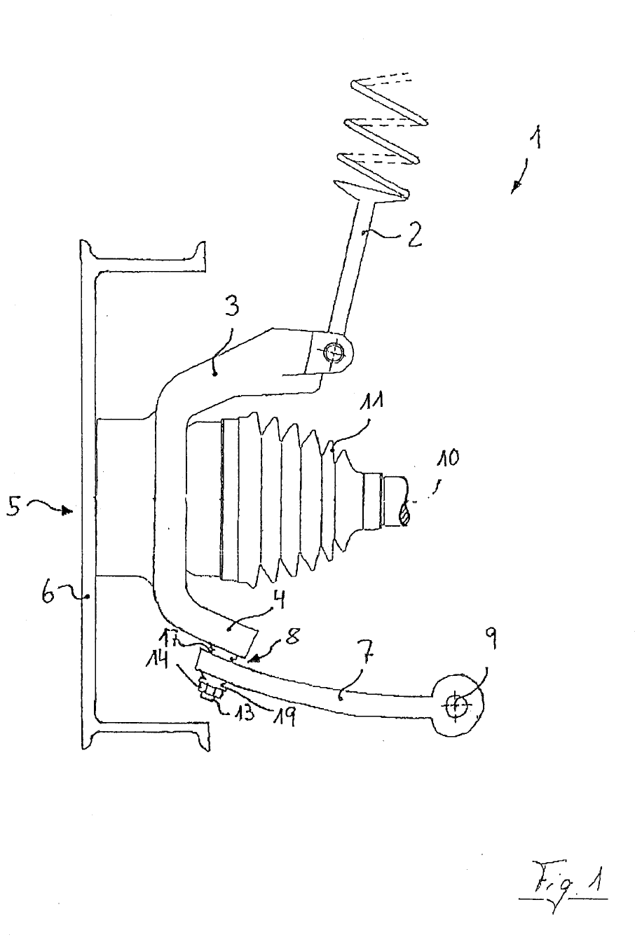

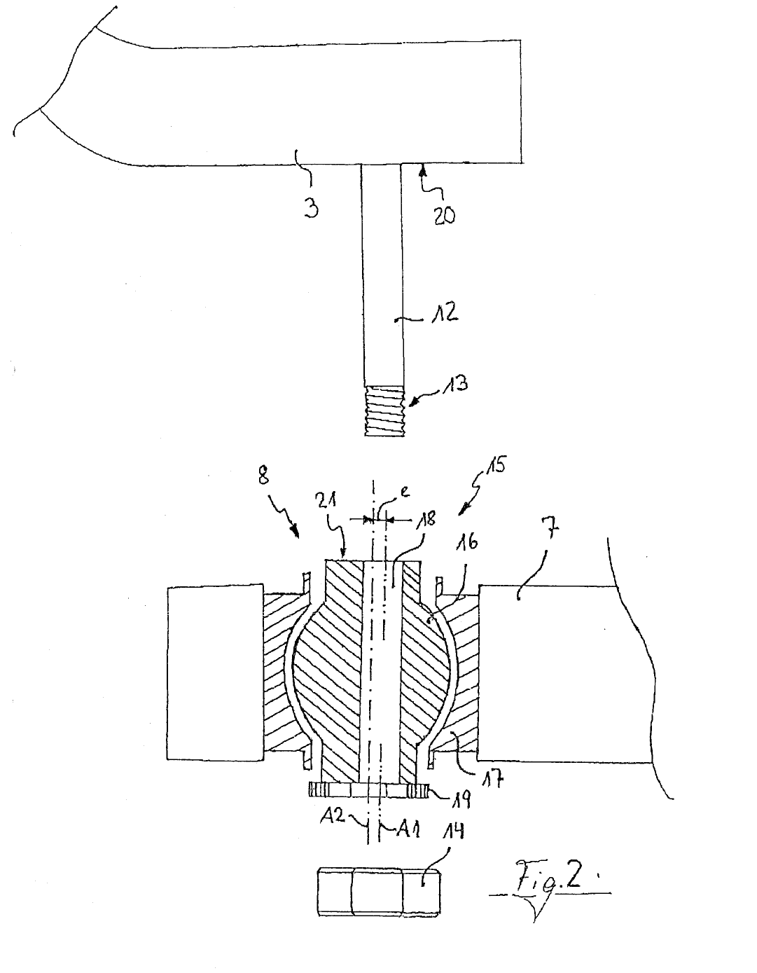

Referring to the drawings in particular, the first exemplary embodiment (FIG. 1 through FIG. 3) shows an eccentric sleeve joint 15.

The detail of a chassis shown as an example in FIG. 1 shows an axle in McPherson arrangement 1, which is also used in this manner, in principle, in the second exemplary embodiment, and in which a spring strut 3 acts on the upper end of a wheel carrier 2 and an extension arm 4 is provided at the lower end of the wheel carrier 2, where the extension arm 4 points with one component in the direction of the transverse center of the vehicle and the wheel carrier 3 is connected via the extension arm 4 to a suspension arm 7, which carries or at least guides the wheel 5, indicated by the rim 6, via a joint and/or bearing arrangement 8. The control arm 7 is designed here as a so-called triangular suspension arm and is articulated pivotably to the body (chassis) about an axis 9 extending at least nearly along the vehicle.

A drive shaft 10, which is in turn surrounded by a gasket 11, passes through the wheel carrier 3.

Instead of a McPherson arrangement, it is possible to use other geometries as well. It is also possible, for example, to provide an arrangement with an upper suspension arm 7 and a lower suspension arm 7. Exemplary embodiments with only one lower suspension arm 7 will be described below.

According to the first exemplary embodiment in the drawing, exactly one pin 12 is associated with the wheel carrier 3, the pin pointing rigidly outwardly from the wheel carrier, pointing downward with one component towards the suspension arm 7 and being received at same in the joint arrangement 8.

The pin 12 may be rigidly connected to the wheel carrier 3, for example, by means of a press fit or weld in a recess prepared there. As an alternative, the pin 12 may also be made integrally in one piece with the wheel carrier 3. In any case, the unit comprising the wheel carrier 3 and the pin 12 may be delivered to the assembly line in the completely mounted state.

Depending on the geometry, the pin 12 may have a cross-sectional shape deviating from a rotational symmetry, for example, an elliptical or triangular cross section, to counteract a preferred direction of stress. Unlike as shown in FIG. 1, the pin 12 also does not have to have a uniform cross section over its entire length, but it may also taper, for example, conically, hyperbolically or parabolically or be stepped.

A fastening means 14, which secures the connection of the end 13 to the suspension arm 7, can be attached to the end 13 of the pin 12, which said end points radially outwardly in relation to the wheel axle. An external thread, which can be secured by means of a nut 14, is provided at the pin end 13 here.

In the mounted state, the pin 12 passes through the suspension arm 7, so that the fastening element 14 can be attached to the pin 12 on the side located on the other side of the suspension arm 7, i.e., on the underside of the suspension arm 7 here. A fastening means, which would have to be introduced into the space between the extension arm 4 and the drive shaft 11, can thus be eliminated altogether.

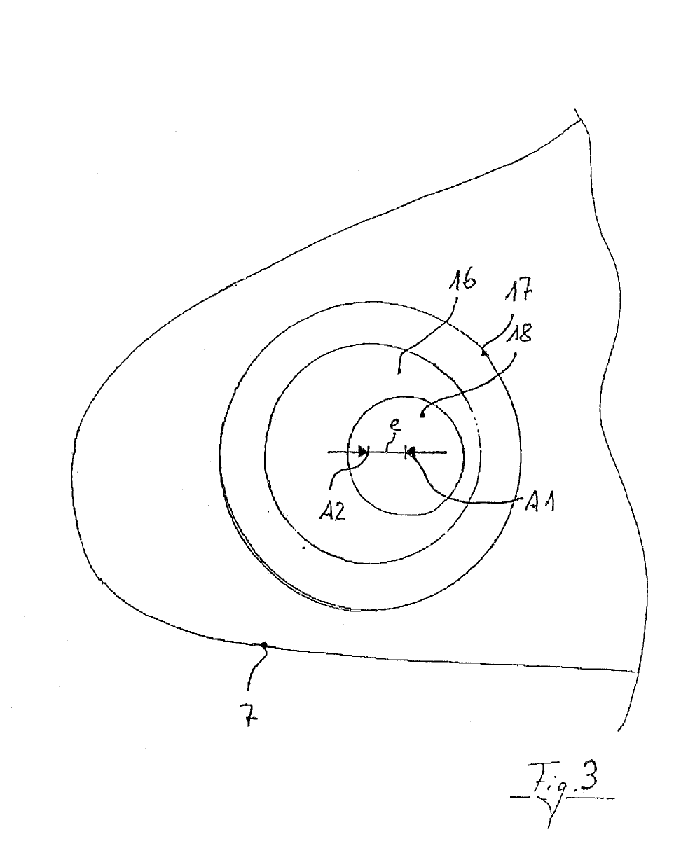

As can be determined, for example, from FIG. 3, the pin 12 may be accommodated at the suspension arm 7 in a joint arrangement 8, which is designed as a sleeve joint 15 and whose joint shell 17 is pressed into the suspension arm 7 or can be welded in, for example, with a circumferential weld seam or can only be screwed to same. The exact arrangement of the sleeve joint 15 therefore depends on the particular geometries in the vehicle.

To make it possible to compensate manufacturing tolerances of the suspension arm, the articulation thereof, of the body or of other parts, the sleeve joint 15 has an eccentric through hole 18 with a joint axis A1 for receiving the pin 12. The joint axis A1 is offset in parallel by the eccentricity e in relation to the central axis A2 of the joint body 16. It becomes possible as a result during mounting to connect at first the wheel carrier 3 to the suspension arm 7 by passing the pin 12 through the hole 18 and by subsequently performing a fine adjustment especially in the transverse direction of the vehicle in this connection position, in which the wheel orientation can be easily checked by inspection: The joint body 16 of the sleeve joint 15 has for this, at its end that is the lower end here, a hexagon insert bit 19 or another possibility of attachment for a tool, with which the joint body 16 can be rotated until the set camber corresponds to a preset set value. This position can then be fixed by attaching the nut or another fastening element 14 on the pin end 13 passing through downwardly and tightening it, as a result of which the lower edge 20 of the extension arm 4 is rigidly braced with the upper edge 21 of the joint body 16.

The use of an eccentric and settable joint arrangement 8 facilitates mounting and makes it possible, despite the possibility of setting, to tighten only one fastening means 14 or to remove only one fastening means 14 for disassembly, which means a considerable facilitation of work, for example, compared to an adapter solution with a plurality of elongated holes and means, moreover, a weight reduction.

The joint 15 can be stressed both axially and radially on bending.

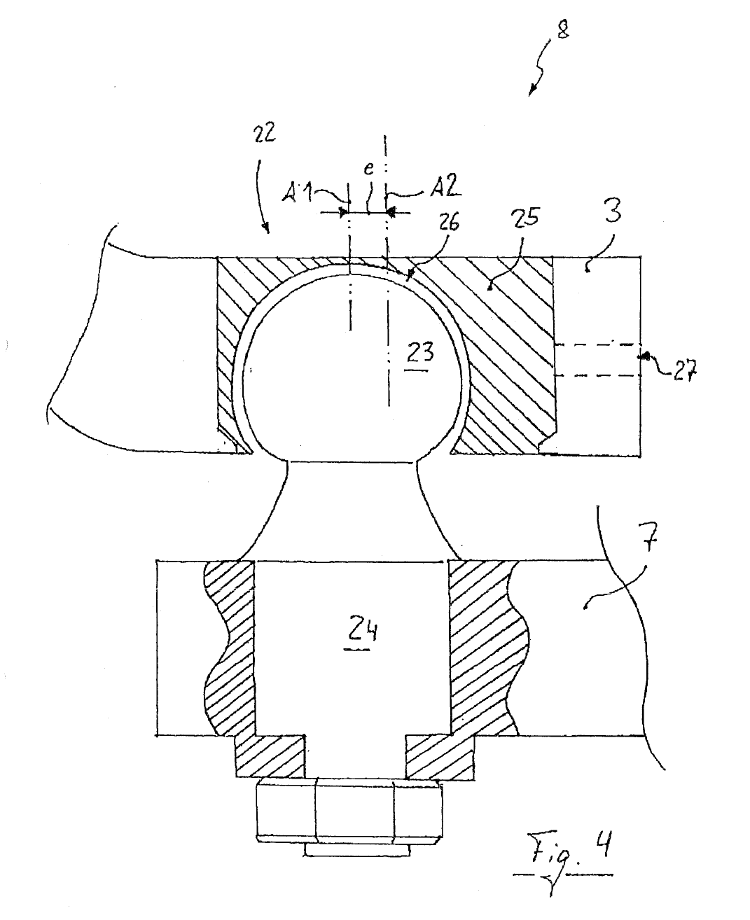

In a second exemplary embodiment according to FIG. 4, a joint 22, which can likewise be stressed on bending and axially, is provided, with a ball head 23, in which the ball head 23 is seated axially on the pin 24 and is braced, for example, with the cross rail 7, welded or pressed into same. The threaded shell 25 fixed at the wheel carrier 3 is, by contrast, of an eccentric design.

The joint axis A1 as a central axis of the mount 26, which is flush with the axis of the pin 24 and of the ball head 23 in the connected position, is offset by an eccentricity e in parallel in relation to the central axis A2, which vertically intersects, as an axis passing through the center, the circle defined by the outer contour of the threaded shell 25.

Orientation is also possible here in the connected position, namely, by rotating the joint shell 25 about the central axis A2 until, for example, the camber corresponds to the set position. The set angle of rotation about the axis A2 can then be secured by means of a screw meshing with the channel 27 laterally or in another manner.

As an alternative, not shown, the joint shell 25 could be rotationally symmetrical and the axis of the pin 24 could be eccentrically offset in relation to the ball head 23, which could lead, in principle, on the whole, to the same position of the parts 3 and 7 in relation to one another. The eccentric ball head 23 could be rotatable either from below via a tool attachment on the pin 24, for example, a hexagon insert bit or a hexagon socket or a passage through the joint shell.

While specific embodiments of the invention have been shown and described in detail to illustrate the application of the principles of the invention, it will be understood that the invention may be embodied otherwise without departing from such principles.

1-11. (canceled)

12. A joint arrangement including a joint which can be stressed at least axially and on bending, the joint comprising:
an outer joint shell;
an inner joint body movable in relation to said joint shell and providing a joint axis located at a spaced location from a central axis located centrally in said joint.

13. A joint arrangement in accordance with claim 12, wherein said joint axis is located extending in parallel to said central axis.

14. A joint arrangement in accordance with claim 12, further comprising eccentricity adjustment means for adjusting a spacing of said joint axis from said central axis whereby an eccentricity of said joint axis in relation to said central axis can be set and fixed.

15. A joint arrangement in accordance with claim 12, wherein said joint is a sleeve joint with an eccentrically arranged through hole.

16. A joint arrangement in accordance with claim 12, wherein said joint comprises as a joint body, with a ball head movable in said joint shell, and a joint pin extending eccentrically from said ball head.

17. A joint arrangement in accordance with claim 12, wherein said joint comprises a joint body with a ball head movable in said joint shell and a joint pin extending centrally in relation to said ball head, said joint shell being movable about a central axis.

18. A joint arrangement in accordance with claim 12, further comprising:
a motor vehicle chassis;
a suspension arm connected to said motor vehicle chassis; and
a wheel carrier guiding and/or carrying a wheel, said joint providing an articulated connection between said suspension arm and said wheel carrier.

19. A joint arrangement in accordance with claim 18, wherein said joint includes a pin extending rigidly from said wheel carrier, said inner joint body receiving said pin at said suspension arm.

20. A motor vehicle chassis in accordance with claim 19, wherein said suspension arm is a lower suspension arm, which receives said pin as a downwardly extending component.

21. A joint arrangement in accordance with claim 18, comprising a McPherson axle with said joint arranged between said wheel carrier and said suspension arm.

22. A joint arrangement comprising:
a first part;
a second part; and
a joint with an outer joint shell connected to said first part and an inner joint body with a joint pin connected to said second part, joint body being movable in relation to said joint shell, said joint having a joint central axis and one of said joint shell and said joint body defining a joint axis located at a spaced location from said joint central axis to define an eccentricity, said joint being stressed at least axially and on bending the joint.

23. A joint arrangement in accordance with claim 22, further comprising eccentricity adjustment means for adjusting said eccentricity to change a spacing of said joint axis from said central axis whereby an eccentricity of said joint axis in relation to said central axis can be set and fixed.

24. A joint arrangement in accordance with claim 22, wherein said joint is a sleeve joint and said joint body has an eccentrically arranged through hole cooperating with a joint pin.

25. A joint arrangement in accordance with claim 22, wherein said joint comprises as a joint body with a ball head movable in said joint shell and a pin extending eccentrically from said ball head.

26. A joint arrangement in accordance with claim 22, wherein said joint comprises as a joint body with a ball head movable in said joint shell and a joint pin extending centrally in relation to said ball head, said joint shell being movable about said central axis and receiving said ball head at a spaced location from said joint central axis to define said eccentricity.

27. A joint arrangement in accordance with claim 22, further comprising
a motor vehicle chassis, wherein said first part is a suspension arm connected to said motor vehicle chassis and said second part is a wheel carrier guiding and/or carrying a wheel, said joint providing an articulated connection between said suspension arm and said wheel carrier.

28. A joint arrangement in accordance with claim 18, comprising a McPherson axle with said joint arranged between said wheel carrier and said suspension arm.

29. A motor vehicle comprising:
a motor vehicle chassis;
a suspension arm connected to said motor vehicle chassis;
a wheel carrier guiding and/or carrying a wheel;
a joint providing an articulated connection between said suspension arm and said wheel carrier, said joint comprising an outer joint shell connected to one of said suspension arm and said wheel carrier and an inner joint body with a joint pin connected to the other of said suspension arm and said wheel carrier, said joint body being movable in relation to said joint shell, said joint having a joint central axis and one of said joint shell and said joint body defining a joint axis located at a spaced location from said joint central axis to define an eccentricity, said joint being stressed at least axially and on bending the joint.

30. A joint arrangement in accordance with claim 29, further comprising eccentricity adjustment means for adjusting said eccentricity to change a spacing of said joint axis from said central axis whereby an eccentricity of said joint axis in relation to said central axis can be set and fixed.

31. A joint arrangement in accordance with claim 29, wherein said joint is a sleeve joint and said joint body has an eccentrically arranged through hole cooperating with a joint pin.
